(19) United States
(12) Patent Application Publication
(10) Pub. No.: US 2005/0263941 A1
(43) Pub. Date: Dec. 1, 2005

(54) Apparatus and method for melt spinning dyed yarn filaments

(75) Inventors: Tilman Reutter, Schonboken (DE); Diethard Hubner, Bordesholm (DE); Jorn Zuhlke, Wankendorf (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Saurer GmbH & Co. KG

(21) Appl. No.: 11/189,450

(22) Filed: Jul. 26, 2005

Related U.S. Application Data
(63) Continuation of application No. PCT/EP04/00511, filed on Jan. 22, 2004.

(30) Foreign Application Priority Data
Jan. 29, 2003 (DE) 103 03 356.4

(51) Int. Cl. B29C 47/36

(52) U.S. Cl. 264/211.22; 425/200

(57) ABSTRACT

An apparatus and a method for spinning dyed filaments from a dyed polymer melt, wherein an undyed polymer melt is produced by a melt producer. A liquid dye is added to the polymer melt by means of a dye metering device. To mix the liquid dye and dye the polymer melt, a mixing unit is provided. The dyed polymer is then spun to filaments by means of a spin unit. To obtain before the spinning step a uniform coloration of the polymer melt despite the short dwelling time of the liquid dye in the polymer melt, the liquid dye and the polymer melt are mixed in a plurality of successive mixing units which are formed by a mixer combination comprising at least one static mixer and at least one dynamic mixer.

### CROSS REFERENCE TO RELATED APPLICATION

The present application is a continuation of international application PCT/EP2004/000511, filed 22 Jan. 2004, and which designates the U.S. The disclosure of the referenced application is incorporated herein by reference.

### BACKGROUND OF THE INVENTION

The invention relates to an apparatus for spinning dyed filaments from a dyed polymer melt, as well as a method for spinning dyed filaments from a dyed polymer melt. An apparatus and a method of this general type are disclosed, for example, in DE 199 56 251 A1.

To be able to produce dyed filaments to e used in forming endless carpet yarns, it is necessary to dye the base polymers by adding dyes before spinning. To this end, different variants of apparatus and methods are known in the art. In a first variant, the dye is supplied together with the granules of the base polymer to a melt producer, so that melting and mixing are carried out by the melt producer in one step. Systems of this type are disclosed, for example, in U.S. Pat. Nos. 5,756,020 and 6,182,685. However, the known apparatus have in general the disadvantage that when a dye is changed, it will be necessary to flush the apparatus completely from the melt producer right to the individual spinnerets, so that long downtimes result.

For this reason, methods and devices have been developed in particular for flexible apparatus for spinning dyed filaments, wherein the dyes are added directly to the polymer melt after melting the base polymer. For example, as disclosed in EP 0 837 161 A1 or EP 1 054 083 A1, an intensive mixing occurs after combining the dye with the polymer melt to obtain the desired coloration of the polymer melt. Thus, the feed point of the dye can be relocated from the melt producer toward the spinnerets, so that when a dye is changed, it will be possible to obtain shorter downtimes by expending less time for flushing. The addition of the dye after the melt production, however, leads to shorter dwelling times and reaction times between the dye and the polymer melt to obtain an intensive and uniform coloration of the polymer melt.

In particular, when liquid dyes are used as disclosed in DE 199 56 251 A1, the short reaction time leads to dye irregularities in the spun filaments. In the known apparatus and known method, the liquid dye is additionally mixed by a static or dynamic mixer only in the region between a spin pump and a spinneret. In this process, the very short dwelling times of the liquid dye in the polymer melt complicate a uniform coloration of all melt components.

It is therefore an object of the invention to further develop an apparatus and a method of the initially described type such that before spinning, a very uniform coloration of the polymer melt is obtained by a liquid dye that is added to the polymer melt in a metered quantity.

### SUMMARY OF THE INVENTION

The above and other objects and advantages of the invention are achieved by the provision of a melt spinning method and apparatus for producing dyed polymeric filaments, and wherein in a very short time after adding the liquid dye to an undyed melt, a uniform distribution of the dye is achieved, and which leads to a uniform coloration of the polymer melt. To this end, the apparatus of the invention includes a mixer combination consisting of at least one static mixer and at least one dynamic mixer, so that the liquid dye and the polymer melt can be mixed in a plurality of successively occurring mixing operations. The combination of static mixing with dynamic mixing has a special effect on a uniform distribution of the liquid dye within the polymer melt.

A further advantage of the invention lies in that the location of the dye addition between the melt producer and the spinneret is freely selectable, so that a great flexibility results in the production of dyed filaments. Thus, the invention can be used for spinning single color yarns, multicolored yarns, or colored staple filaments, as well as spunbonds.

As a function of the used base polymer, with all spinnable and dyeable base polymers being basically suited, it is possible to carry out the mixing steps in certain, predetermined sequences. To this end, the static mixer may be arranged within the mixer combination in the direction of the flow either upstream or downstream of the dynamic mixer.

It is likewise possible to use besides the dynamic mixer, a plurality of static mixers alternately or serially connected. However, it is also possible to provide besides one or more static mixers a plurality of dynamic mixers.

To spin single color filaments, it is preferred to use the further development of the invention, wherein the polymer melt is dyed after having been produced and before being divided into a plurality of partial melt flows. In this case, the mixing unit and the dye metering device are arranged in the flow direction upstream of a melt distributor, which is arranged for dividing the polymer melt between the melt producer and the spinning unit. With that, the required number of units for dying the polymer melt is also kept small.

In the case that spinning of multicolor filaments requires a high flexibility in coloration and dye change, the further development of the invention is especially advantageous, wherein the polymer is dyed after being divided into a plurality of partial melt flows. In this case, a feed device and a mixing unit are associated to each partial melt flow, so that each of the partial flows advances through a plurality of mixing operations.

A further, particularly preferred realization of the invention, wherein a plurality of melt distributors are associated to the melt producer, and wherein a separate mixing unit with a dye metering device is associated to the melt distributor, is used in particular for spinning so-called tricolor yarns. In this case, a mixed yarn is produced from three differently dyed individual yarns. Thus, each of the dye metering devices associated to the melt distributors is used to supply different liquid dyes. However, this arrangement is also advantageous to produce multicolor yarns, which are formed of 4, 5, or even more colors.

The method and the apparatus of the invention are especially suited for temperature insensitive additives, which must also be added to the melt spinning process, in the same way as the dye, at the latest possible stage. In this respect, the invention is not limited to spinning dyed filaments, but also encompasses those methods and apparatus, wherein an additive is used exclusively in the place of the liquid dye.

### BRIEF DESCRIPTION OF THE DRAWINGS

In the following, the apparatus and method of the invention are described in greater detail by means of some embodiments with reference to the attached drawings, in which:

FIG. 1 is a schematic view of a first embodiment of an apparatus according to the invention for spinning single color filaments;

FIG. 2 is a schematic view of a further embodiment of the apparatus according to the invention for spinning dyed filaments;

FIG. 3 is a schematic view of a further embodiment of the apparatus according to the invention for spinning multicolor filaments; and

FIG. 4 is a schematic view of a further embodiment of the apparatus according to the invention for spinning single color filaments.

### DETAILED DESCRIPTION OF THE PREFERRED EMBODIMENTS

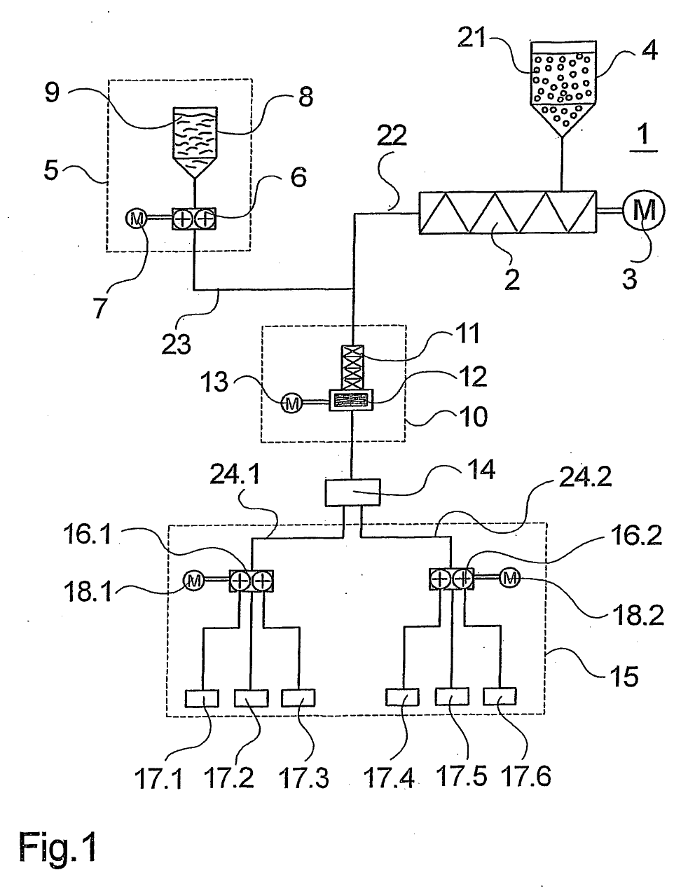

FIG. 1 illustrates a first embodiment of an apparatus according to the invention for spinning single color filaments to produce from the filaments, for example, crimped carpet yarns. To this end, the apparatus comprises a melt producer 1. The melt producer 1 is shown as an extruder with an extruder screw 2 and an extruder drive 3. The melt producer 1 includes a feed hopper 4 for receiving granules 21. The melt producer 1 connects to a melt line 22.

Into the melt line 22, a feed line 23 extends, which connects to a dye metering device 5. The dye metering device 5 comprises a metering pump 6 and a tank 8 connecting to the metering pump 6. The metering pump 6 is driven via a drive 7. The tank 8 holds a liquid dye 9. In the direction of the flow, downstream of the inlet of feed line 23, a mixing unit 10 connects to the melt line 22. The mixing unit 10 comprises a static mixer 11 and a dynamic mixer 12 that is driven by a drive 13. The static mixer 11 and dynamic mixer 12 are combined to a structural unit. The static mixer 11 precedes the dynamic mixer 12.

In the direction of flow, the mixing unit 10 is followed by a melt distributor 14, which connects to a spin unit 15. The spin unit 15 comprises two spin pumps 16.1 and 16.2, which are each driven by a pump drive 18.1 and 18.2. Each of the spin pumps 16.1 and 16.2 connects via a separate distributor line 24.1 and 24.2 to the melt distributor 14. Inside the melt distributor 14, the melt received from the mixing unit 10 is divided into the distributor lines 24.1 and 24.2. Associated to the spin pump 16.1 are a total of three spinnerets 17.1-17.3. Associated to the spin pump 16.2 are spinnerets 17.4-17.6.

In the embodiment shown in FIG. 1, the granules 21 of a base polymer, for example, polypropylene or polyamide are supplied via feed hopper 4 to the extruder screw 2. The granules 21 are melted by the melt producer 1 to an undyed polymer melt and removed as a pressurized melt flow via the melt line 22. To the flow of the undyed polymer melt, a liquid dye 9 is added in a measured quantity by the dye metering device 5. To this end, the metering pump 6 is driven via the metering drive 7 at a certain speed, so that a defined quantity of liquid dye 9 is supplied from the tank 8 via the feed line 23 into the melt line 22. Subsequently, the polymer melt and liquid dye jointly enter the mixing unit 10. In so doing, both components undergo a static mixing in the static mixer 11. To this end, the static mixer 11 could comprise, for example, a plurality of chambers with a plurality of stationary mixing elements, which cause an intensive deflection of the advancing polymer melt and liquid dye. From the static mixer 11, the components then enter directly the dynamic mixer 12. In the dynamic mixer 12, a further thorough mixing occurs by at least one mixing element that is driven by mixer drive 13. The initial mixing having been preset by the static mixer 11 is thus intensified, so that the particles of the liquid dye are evenly distributed within the polymer melt. The thus dyed polymer melt is then distributed via the melt distributor 14 to the individual spin pumps 16.1 and 16.2. The spin pumps 16.1 and 16.2 are constructed as single or multiple gear pumps, which produce a plurality of partial flows. The spin pump 16.1 delivers a partial flow to each of the spinnerets 17.1-17.3. Each of the spinnerets includes in its underside a plurality of spin holes, so that by means of the pump pressure the dyed polymer melt is spun to strandlike filaments. Likewise, additional dyed filaments are spun via the spin pump 16.2 and spinnerets 17.4-17.6.

In the embodiment shown in FIG. 1, the polymer melt is dyed before being distributed by melt distributor 14. This arrangement is used in particular for spinning single color filaments.

The embodiment of FIG. 1 is also suited for adding to the melt flow an additive in the place of the liquid dye. To this end, the tank 8 would be filled with the additive, which the metering pump 6 would add to the main melt flow. The subsequent mixing would then proceed as described above.

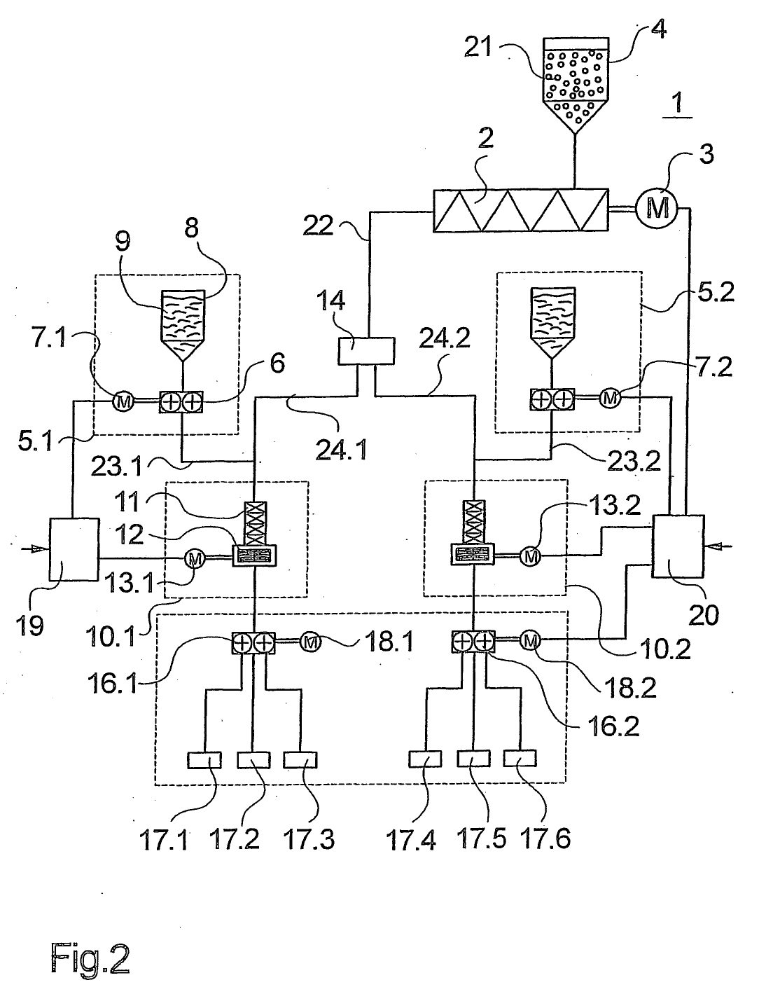

To be able to produce filaments of different colors, it is preferred to use the embodiment of the apparatus according to the invention as shown in FIG. 2. In the embodiment of FIG. 2, the melt producer 1, the melt distributor 14, and the spin unit 15 are made identical with the foregoing embodiment of FIG. 1, so that at this point the foregoing description is herewith incorporated by reference. To dye the polymer melt, the present embodiment is provided with respectively two dye metering devices 5.1 and 5.2 and two mixing units 10.1 and 10.2. In this case, the dye metering device 5.1 and the mixing device 10.1 are arranged between the melt distributor 14 and the spin pump 16.1. The second dye metering device 5.2 and the second mixing unit 10.2 are associated to a distributor line 24.2 and positioned between the melt distributor 14 and the spin pump 16.2. The construction of the dye metering devices 5.1 and 5.2 as well as of the mixing units 10.1 and 10.2 is identical with the embodiment of FIG. 1, so that likewise at this point the foregoing description is herewith incorporated by reference.

In the embodiment shown in FIG. 2, each of the formed partial melt flows in the distributor lines 24.1 and 24.2 is separately and independently dyed after dividing the main melt flow by melt distributor 14. In this process, the undyed polymer melt is supplied from a melt producer 1 to the melt distributor 14. From the melt distributor 14, the polymer melt is divided into the connecting distributor lines 24.1 and 24.2. Via feed lines 23.1 and 23.2, a defined quantity of liquid dye is added to each of the partial melt flows, which are subsequently mixed by mixing units 10.1 and 10.2. After being mixed in several mixing steps, the dyed polymer melt is delivered by spin pumps 16.1 and 16.2 to the spinnerets 17.1-17.6, so that the dyed filaments can be spun. In this embodiment, it is possible to add to the partial melt flows different liquid dyes or identical dyes respectively via the dye metering devices 5.1 and 5.2.

FIG. 2 illustrates different possibilities of controlling the drives of dye metering devices 5.1 and 5.2. For example, it is possible to adjust the mixer drive 13.1 as a function of the metered quantity. To this end, the mixer drive 13.1 and the metering drive 7.1 are connected to a controller 19. It is also possible to control all drives via a common control unit 20. To this end, FIG. 2 shows in the right half a possibility, wherein the extruder drive 3, the metering drive 7.2, the mixer drive 13.2, and the pump drive 18.2 connect to the control unit 20. With that, it is possible to change, for example, the metered quantity as a function of the throughput. It is likewise possible to adjust the mixer drive 13 in the case of a changed throughput or changed metered quantity.

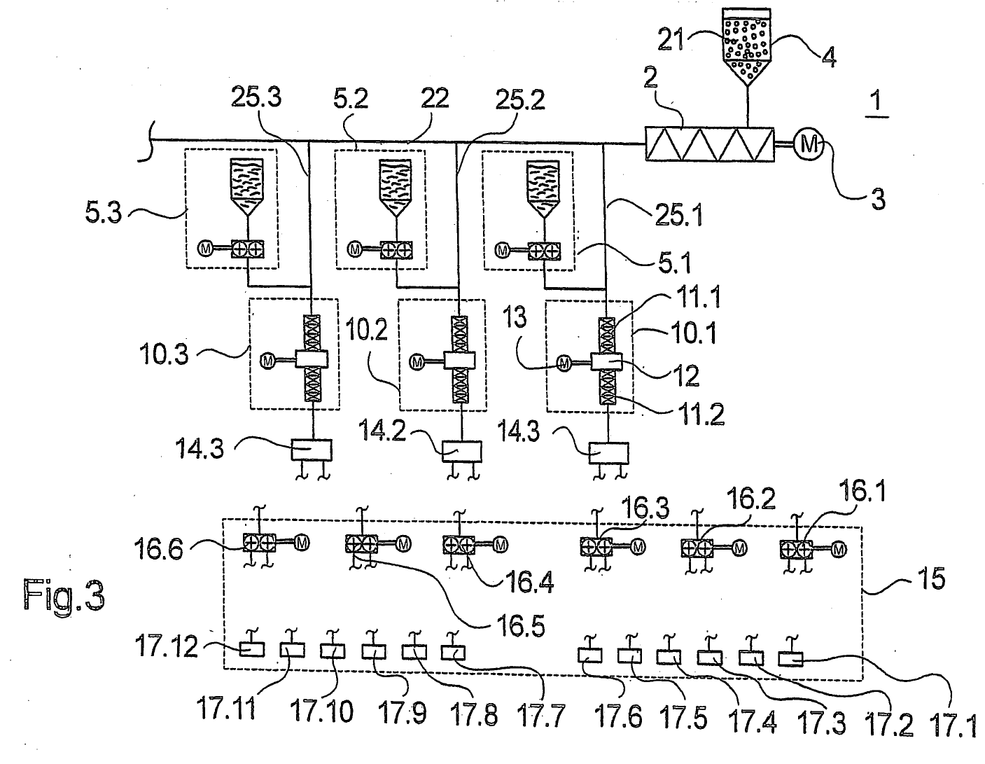

FIG. 3 illustrates a further embodiment of an apparatus according to the invention, which is used for spinning multicolor mixed yarns. The embodiment comprises a melt producer 1, which is constructed identical with the foregoing embodiments. The melt producer 1 connects to a melt line 22. From the melt line 22, a plurality of branch lines 25.1-25.3 branch off. Each of the branch lines 25.1-25.3 ends in a melt distributor 14.1-14.3. Arranged upstream of each of the melt distributors 14.1-14.3 are respectively a dye metering device 5.1-5.3 and a mixing unit 10.1-10.3. The dye metering devices 5.1-5.3 are identical with the foregoing embodiments, so that they are not described in greater detail. The mixing units 10.1-10.3 are of identical construction. Each of the mixing units comprises a mixer combination, namely, as is described with reference to the example of mixing unit 10.1, a static mixer 11.1, a dynamic mixer 12, and a second static mixer 11.2. The dynamic mixer 12 is driven by a drive 13.

Arranged downstream of each mixing unit 10.1-10.3 is a melt distributor 14.1-14.3 for distributing the melt to a spin unit 15. The spin unit 15 is constructed such as to produce parallel four colored mixed yarns. Each of the mixed yarns is combined by three individual yarns, with each of the individual yarns of a mixed yarn being differently dyed. Mixed yarns of this type are also referred to as tricolor yarns, which are imparted a crimp in further treatment steps, and which are used as carpet yarns. To distribute the differently dyed partial melt flows, two spin pumps of the total of six spin pumps 16.1-16.6 are respectively associated to each of the melt distributors 14.1-14.3. Each of the spin pumps 16.1-16.6 delivers to two spinnerets of a total of twelve spinnerets 17.1-17.12 for spinning respectively one dyed individual yarn from a plurality of strandlike filaments.

In the embodiment shown in FIG. 3, the dye metering devices 5.1-5.3 supply each different liquid dyes to the polymer melts advancing in the branch lines 25.1-25.3. The subsequent mixing of the respective liquid dye with the polymer melt occurs by the mixing units 10.1-10.3. There, each partial flow is mixed in a sequence of three mixing steps. A first static mixing is followed by a dynamic mixing as well as a further static mixing. Subsequently, the three differently dyed polymer melts advance via the melt distributors 14.1-14.3 to the spin pumps 16.1-16.6 as well as the spinnerets 17.1-17.12. The distribution to the spinnerets 17.1-17.12 occurs such that three adjacent spinnerets spin three differently dyed filament strands, which are combined to a mixed yarn. The present embodiment has the special advantage that the production of such tricolor yarns requires only one melt producer. The coloring of the polymer melt with three different liquid dyes occurs independently of the melt production. With that, it is also possible to use such apparatus without any major readjustment of the melt distribution for producing undyed, single color, or multicolor yarns. The number of the dyes as well as the dye metering devices are exemplary. Basically, it is also possible to spin at the same time more than three dyed filament strands.

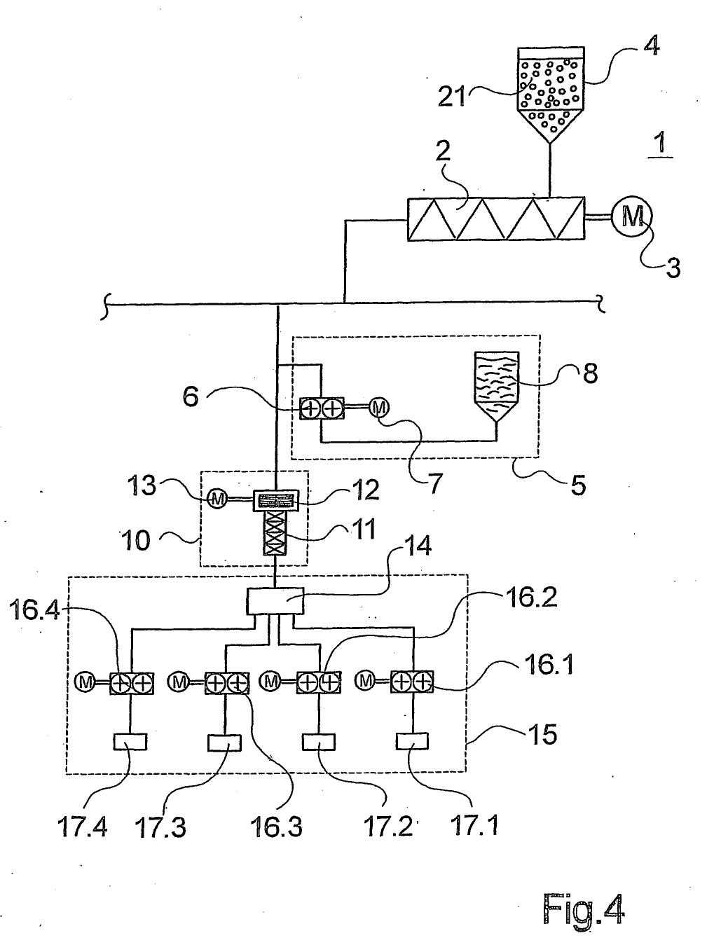

FIG. 4 illustrates a further embodiment of an apparatus according to the invention for spinning dyed filaments. The embodiment is largely identical with the embodiment of FIG. 1, so that at this point the foregoing description is herewith incorporated by reference, and only differences are described.

The embodiment shown in FIG. 4 is used for spinning filament strands, which are cut to staple filaments directly in the spinning process or in a subsequent process. To this end, the strandlike filaments are spun from annular spinnerets 17.1-17.4 of the spin unit 15. Associated to each spinneret 17.1-17.4 is a separate spin pump 16.1-16.4. The spin pumps 16.1-16.4 connect via a melt distributor 14 to the main flow of a melt producer 1. Arranged upstream of the melt distributor 14 are a dye metering device 5 and a mixing unit 10. The dye metering device corresponds to the foregoing embodiments. The mixing unit 10 is formed by a mixer combination, wherein a dynamic mixer 12 precedes a static mixer 11. Thus, the liquid dye supplied by the dye metering device 5 undergoes a mixing with the polymer melt in the successive steps of a dynamic mixing by the dynamic mixer 12 and a static mixing by the static mixer 11.

The embodiments shown in FIGS. 1-4 are exemplary in their arrangement and construction of the individual units. For example, dyeing of the polymer melt may also be supplemented by additional subsequent mixing operations. It is furthermore possible to combine the drives of the dynamic mixer and the spin pump, so that the dynamic mixer and the spin pump can be jointly driven by one drive. In particular, it is possible to use additional static and/or dynamic mixers directly upstream of the spinnerets and/or spin pumps.

It is likewise possible to change the combination of the sequence of static mixers, dynamic mixers, and pumps in any way, for example, to a sequence of a static mixer, a dynamic mixer, a pump, a static mixer, and a spinneret.

The invention also extends to such apparatus and methods, wherein a different additive is added to the melt flow in the place of the liquid dye. Likewise in this case, one obtains the advantageous effect that the particles of the additives are contained in a constant distribution already after a short time.

In practical operation, the melt carrying components are heated in addition. For example, the spinnerets and spin pumps of the spin unit 15 are arranged in a heated spin beam. In this arrangement, it is possible to arrange the melt distributors 14 either separately outside the spin beam or directly inside the spin beam. Accordingly, the liquid dye can be added outside or inside the spin beam. In addition, it is possible to use heated metering devices, to be able to add the dye or additive already in a preheated state.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus for melt spinning dyed polymeric filaments comprising
a melt producer for producing an undyed polymer melt and delivering the melt serially to a metering device for adding a liquid dye, a mixing unit for mixing the liquid dye and the melt, and then to a spin unit where the dyed melt is extruded into filaments, and
wherein said mixing unit comprises at least one static mixer and at least one dynamic mixer.

2. The apparatus of claim 1, wherein within the mixing unit, the static mixer is arranged in the direction of the melt flow upstream of the dynamic mixer.

3. The apparatus of claim 1, wherein within the mixing unit, the dynamic mixer is arranged in the direction of the melt flow upstream of the static mixer.

4. The apparatus of claim 1, wherein within the mixing unit, a plurality of static mixers are associated to a dynamic mixer, or a plurality of dynamic mixers are associated to a static mixer.

5. The apparatus of claim 1, further comprising a melt distributor for forming a plurality of partial melt flows arranged between the melt producer and the spin unit, and wherein the mixing unit and the dye metering device precede the melt distributor in the direction of the melt flow.

6. The apparatus of claim 1, further comprising a plurality of melt distributors for forming a plurality of partial melt flows arranged between the melt producer and the spin unit, and wherein one of a plurality of mixing units and one of a plurality of dye metering devices are associated to each melt distributor.

7. The apparatus of claim 1, further comprising a melt distributor for forming a plurality of partial melt flows which is arranged between the melt producer and the spin unit, and a plurality of mixing units and a plurality of dye metering devices arranged in the direction of the melt flow downstream of the melt distributor to dye the partial melt flows independently of one another.

8. The apparatus of claim 1, wherein the dye metering device comprises at least one metering pump and a tank connecting to the metering pump, with the tank holding the liquid dye.

9. A method for melt spinning dyed polymeric filaments comprising the steps of
extruding an undyed polymeric melt and advancing the melt to a spin unit,
adding a liquid dye to the advancing melt,
mixing the liquid dye and the advancing melt,
spinning the dyed and mixed advancing melt into polymeric filaments in the spin unit, and
wherein the mixing step comprises a plurality of successive mixing operations, with a static mixing occurring in at least one mixing operation and a dynamic mixing occurring in another mixing operation.

10. The method of claim 9, wherein the sequence of the successive mixing operations starts with a static mixing.

11. The method of claim 9, wherein the sequence of the successive mixing operations starts with a dynamic mixing.

12. The method of claim 9, wherein the advancing melt is divided into a plurality of partial melt flows after the step of adding a liquid dye to the melt.

13. The method of claim 9, wherein the advancing melt is divided into a plurality of partial melt flows, and the step of adding a liquid dye to the melt comprises adding the dye to one or more of the partial melt flows.
